(19) United States
(12) Patent Application Publication
(10) Pub. No.: US 2025/0023980 A1
(43) Pub. Date: Jan. 16, 2025

(54) INCOMING CALL PROCESSING METHOD, ELECTRONIC DEVICE, AND STORAGE MEDIUM

(71) Applicant: GUANGDONG OPPO MOBILE TELECOMMUNICATIONS CORP., LTD., Dongguan (CN)

(72) Inventors: Xiang ZHAO, Dongguan (CN); Duoxin WANG, Dongguan (CN)

(73) Assignee: GUANGDONG OPPO MOBILE TELECOMMUNICATIONS CORP., LTD., Dongguan (CN)

(21) Appl. No.: 18/900,774

(22) Filed: Sep. 29, 2024

Related U.S. Application Data
(63) Continuation of application No. PCT/CN2022/142522, filed on Dec. 27, 2022.

(30) Foreign Application Priority Data
Mar. 30, 2022 (CN) 202210329394.X

(51) Int. Cl. H04M 1/72484; H04M 1/72454; H04M 1/72469; H04M 3/42; H04M 3/436; H04W 52/02

(52) U.S. Cl. CPC H04M 1/72484; H04M 1/72454; H04M 1/72469; H04M 3/42059; H04M 3/436; H04W 52/0229; H04W 52/027

(57) ABSTRACT

An incoming call processing method, an electronic device, and a storage medium. The electronic device supports running a first system and a second system, and an operation power consumption of the first system is lower than an operation power consumption of the second system. The method includes receiving, by the first system, an incoming call notification sent by a terminal, where a communication connection is established between the terminal and the electronic device; when the second system is in a dormant state, performing, by the first system, an incoming call reminder based on the incoming call notification; and in response to an incoming call answering operation, waking up, by the first system, the second system; sending, by the first system, an answering notification to the terminal; and when the second system is in a wake-up state, transmitting, by the second system, call data with the terminal.

### CROSS-REFERENCE TO RELATED APPLICATIONS

The present application is a continuation-application of International (PCT) Patent Application No. PCT/CN2022/142522, filed on Dec. 27, 2022, which claims priority of Chinese Patent Application No. 202210329394.X, in the title of “INCOMING CALL PROCESSING METHOD AND APPARATUS, DEVICE AND STORAGE MEDIUM”, filed on Mar. 30, 2022, the entire contents of which are hereby incorporated by reference in their entireties.

### TECHNICAL FIELD

The present disclosure relates to the technical field of electronic devices, and in particular to an incoming call processing method, an apparatus, a device, and a storage medium.

### BACKGROUND

With the continuous development of science and technology, more and more multi-functional electronic devices have come into being, which bring a lot of convenience to users' daily life.

Taking wearable devices as an example, after bound with a smartphone, the wearable device can realize an incoming call reminder function in addition to push display of messages on the smartphone side.

### SUMMARY OF THE DISCLOSURE

The present disclosure provides an incoming call processing method, an electronic device, and a storage medium.

In a first aspect, the present disclosure provides an incoming call processing method, performed by an electronic device; wherein the electronic device supports running a first system and a second system, and an operation power consumption of the first system is lower than an operation power consumption of the second system; wherein the incoming call processing method includes: receiving, by the first system, an incoming call notification sent by a terminal; wherein a communication connection is established between the terminal and the electronic device; in a case where the second system is in a dormant state, performing, by the first system, an incoming call reminder based on the incoming call notification; and in response to an incoming call answering operation, waking up, by the first system, the second system; sending, by the first system, an answering notification to the terminal; and in a case where the second system is in a wake-up state, transmitting, by the second system, call data with the terminal.

In a second aspect, the present disclosure provides an electronic device, including a processor and a memory; wherein the memory stores at least one instruction configured to be executed by the processor to perform the method as above.

In a third aspect, the present disclosure provides a computer-readable storage medium, storing at least one instruction configured to be executed by a processor to perform the method as above.

### BRIEF DESCRIPTION OF THE DRAWINGS

FIG. 1 is a schematic diagram of a dual-core communication software framework corresponding to a second processor according to some embodiments of the present disclosure.

FIG. 2 is a schematic diagram of a dual-core communication software framework corresponding to a first processor according to some embodiments of the present disclosure.

FIG. 3 is a flowchart of an incoming call processing method according to some embodiments of the present disclosure.

FIG. 4 is a flowchart of incoming call processing using an interface notification method according to some embodiments of the present disclosure.

FIG. 5 is an interface schematic diagram of an incoming call processing process using an interface notification method according to some embodiments of the present disclosure.

FIG. 6 is a flowchart of incoming call processing using an interface notification method according to other embodiments of the present disclosure.

FIG. 7 is an interface schematic diagram of an incoming call processing process using an interface notification method according to other embodiments of the present disclosure.

FIG. 8 is a flowchart of an incoming call processing method using a pre-awakening method according to other embodiments of the present disclosure.

FIG. 9 is a flowchart of an incoming call processing method according to other embodiments of the present disclosure.

FIG. 10 is a structural block diagram of an incoming call processing apparatus according to some embodiments of the present disclosure.

FIG. 11 is a structural block diagram of an electronic device according to some embodiments of the present disclosure.

### DETAILED DESCRIPTION

In order to make the purpose, technical solutions, and advantages of the present disclosure clearer, the following embodiments of the present disclosure will be described in further detail in conjunction with the accompanying drawings.

References to “more than one” in this document refer to two or more than two. The character “and/or” describes an association relationship of associated objects, and indicates that three kinds of relationships may exist, e.g., A and/or B, which may be indicated as: A alone, both A and B, and B alone. The character “/” generally indicates that the associated objects are in an “or” relationship.

In the related art, an electronic device is arranged with a single processor, and an operating system running on the processor realizes an incoming call notification alert and a call function. However, in the course of daily use, the electronic device in most cases is only required to realize some functions that require low processing performance. For example, in most cases, a smartwatch or a smart bracelet is only required to carry out a time display and a message prompt. Therefore, keeping the processor in operation for a long period of time does not improve the performance of the electronic device, but rather increases the power consumption of the device, resulting in a shorter endurance of the electronic device (especially in wearable devices with small battery capacity).

In order to reduce the power consumption of the electronic device while ensuring the performance of the electronic device, in a possible implementation, the electronic device is arranged with at least a first processor and a second processor having different processing performance as well as power consumption, which are configured to run a first system and a second system, respectively (i.e., dual-core and dual-system).

When the dual-system electronic device realizes a call function, because the call function requires high processing performance, after receiving an incoming call notification, the call processing is required to be carried out by the second system, and keeping the second system in a working state for a long period of time will result in an increase in the power consumption of the device.

In order to solve the problem of higher power consumption of the device caused by the second system remaining in the working state for a long time, the embodiments of the present disclosure provide a solution in which, for an electronic device that supports a dual system, in a case where the first system, which consumes less power for running, is in the running state, and the second system, which consumes more power for running, is in the dormant state, when an incoming call notification sent by a terminal is received, an incoming call reminder is carried out by the first system based on the incoming call notification. In response to an incoming call answering operation, the first system wakes up the second system and sends an answering notification to the terminal, and then the second system in the wake-up state transmits call data with the terminal.

During the operation of the electronic device, when receiving an incoming call notification, the first system running on the low-power processor carries out an incoming call reminder based on the incoming call notification, in which case the high-power processor is in a dormant state (accordingly, the second system running on the high-power processor is in a dormant state), and the user determines whether to answer the incoming call based on the incoming call reminder. In response to an incoming call answering operation, the first system wakes up the second system and sends an answering notification to the terminal, and the second system carries out a call data transmission with the terminal in the wake-up state, which ensures the performance of the electronic device and reduces the power consumption of the electronic device, thereby improving the endurance of the electronic device.

In the embodiments of the present disclosure, since the first processor and the second processor work asynchronously, and the first system and the second system are required to realize system communication (or known as dual-core communication), in a possible application scenario, the first system is a Real Time Operating System (RTOS) running on a Micro Controller Unit (MCU), and the second system is an Android operating system running on a Central Processing Unit (CPU).

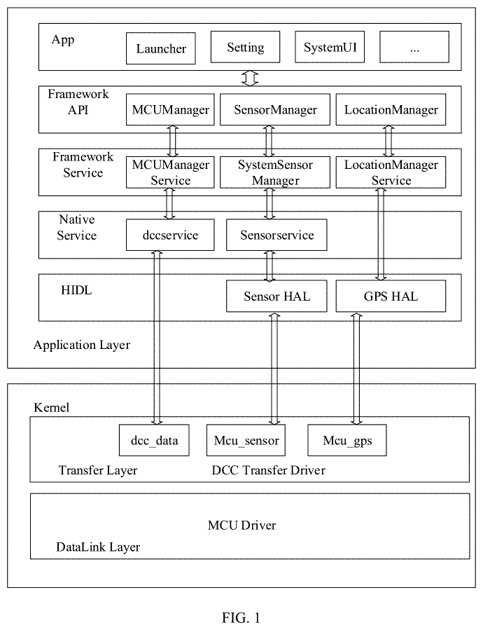

As shown in FIG. 1, FIG. 1 is a schematic diagram of a dual-core communication software framework corresponding to a second processor according to some embodiments of the present disclosure. The dual-core communication software framework follows the design principle of “low coupling, high reliability, high reuse”, including module developments of Kernel, HIDL (hardware abstraction layer (HAL) interface definition language), Native Service, Framework Service, Framework API, and APP (application).

The APP module includes functional modules such as Launcher, Setting, and SystemUI. The Framework API module includes management modules such as MCUManager, SensorManager, and LocationManager. The Framework Service module includes service modules such as MCUManagerService, SystemSensorManager, and LocationManagerService. The Native Service module includes service modules such as dccservice and Sensorservice. The HIDL module includes Sensor HAL, GPS HAL, and other modules. The Kernel module includes DCC Transfer Driver such as dcc_data, Mcu_sensor, and Mcu_gps.

The transfer layer, as the interface layer connecting the upper and lower layers in the dual-core communication software framework, shields the transmission details of the communication of the lower layer of the system (data link layer) to the application layer, and provides service channels for the application scenarios; the application layer, as the main body of the service provision, responds to human-computer interactions, and transmits the data generated in the process of human-computer interactions through the transfer layer and responds to the external data requests.

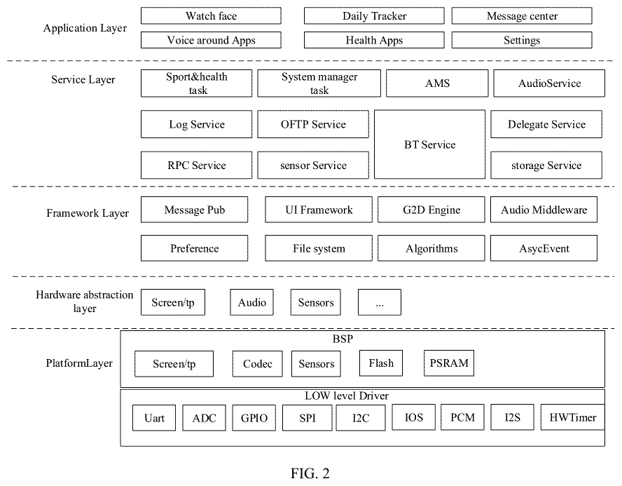

RTOS is designed using the principle of peer-to-peer. As an example, the electronic device is a smartwatch, as shown in FIG. 2, which illustrates a dual-core communication software framework for RTOS illustrated in an exemplary embodiment of the present disclosure.

The dual-core communication software framework for RTOS is divided into an Application Layer, a Service Layer, a Framework Layer, a Hardware abstraction layer, and a Platform Layer.

The Application Layer includes watch face, Daily Tracker, Message center, Voice around Apps, Health Apps, Settings, and other application modules; the Service Layer includes Sport&health task, System manager task, AMS, AudioService, Log Service, OFTP Service, BT Service, Bluetooth Service, Delegate Service, RPC Service, sensor Service, storage Service, and other service modules; the framework layer includes Message Pub, UI Framework, G2D Engine, Audio Middleware, Preference, File system, Algorithms, AsycEvent, and other framework modules; the Hardware abstraction layer includes hardware abstraction modules such as Screen/TP, sensors; the Platform Layer includes Board Support Package (BSP) and LOW level Driver, where the BSP includes Screen/TP, Codec, sensors, Flash PSRAM, and the LOW level Driver includes Uart, ADC, GPIO, SPI, I2C, IOS, PCM, I2S, and HWTimer.

It should be noted that the above dual-core communication software framework is only used for schematic illustration, and those skilled in the art may add, delete, or modify the above framework according to actual needs. The embodiments of the present disclosure do not constitute a limitation on the specific structure of the dual-core communication software framework.

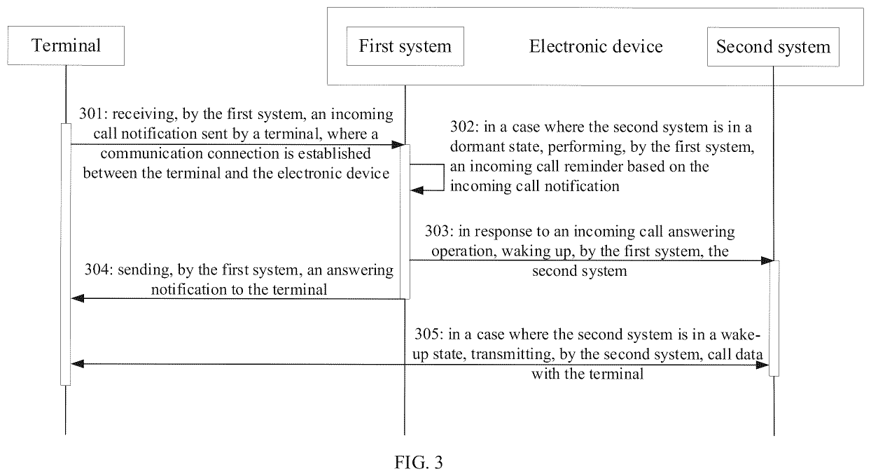

Referring to FIG. 3, FIG. 3 is a flowchart of an incoming call processing method according to some embodiments of the present disclosure. The present embodiment is illustrated by an example in which the method is applied to an electronic device, and the electronic device supports running a first system and a second system (where the operation power consumption of the first system is lower than that of the second system), and the method may include operations illustrated in FIG. 3.

Step 301: receiving, by the first system, an incoming call notification sent by a terminal, where a communication connection is established between the terminal and the electronic device.

In order to reduce the power consumption of the electronic device while ensuring the performance of the electronic device, in a possible implementation, the electronic device is arranged with at least a first processor and a second processor having different processing performance as well as power consumption for running the first system and the second system (i.e., a dual-core dual-system). During the operation of the electronic device, events with low performance processing requirements are processed through a low-power system (which may be the first system or the second system) running on the low-power processor, and the high-power processor is kept in a dormant state (accordingly, the high-power system running on the high-power processor is in a dormant state), which realizes the basic functions of the electronic device and reduces the power consumption of the electronic device at the same time. When there is an event with high-performance processing requirements, the event is processed by waking up the high-power processor and switching the high-power system to process the event, thereby ensuring that the triggered event can be responded to and processed in a timely manner to meet the performance requirements of the electronic device.

In a possible implementation, the electronic device is arranged with a first processor and a second processor, where the processing performance of the first processor is lower than the processing performance of the second processor (the processing power and processing speed of the first processor is lower than that of the second processor), and the power consumption of the first processor is lower than the power consumption of the second processor. Accordingly, the power consumption of the first system running on the first processor is lower than the power consumption of the second system running on the second processor. Thus, the second system is capable of processing the events processed by the first system, while the first system is not necessarily capable of processing the events processed by the second system.

In another possible implementation, the electronic device may be arranged with a single processor, with the first system and the second system running on different cores of the processor, where the processing performance of the core running the second system is higher than the processing performance of the core running the first system.

Taking the electronic device being a smartwatch as an example, the first processor is an MCU, the second processor is a CPU, the first system is an RTOS, and the second system is an Android system. Accordingly, the events that can be processed by the first system include time display, notification message display, and other scenarios or weak interaction scenarios that require low processing performance; and the events that can be processed by the second system include incoming call answering, message replying, function setting, and other scenarios or strong interaction scenarios that require high processing performance.

Unlike smartphones, which are electronic devices with strong interaction attributes, wearable devices, as a kind of auxiliary electronic devices, only have weak interaction with users in most of the usage scenarios. For example, in most scenarios, users only check the time by lifting their wrist with a smartwatch. Therefore, the wearable device controls the second processor to be in a dormant state (i.e. the second system to be in a dormant state) when the wearable device processes events through the first system, thereby reducing the overall power consumption of the wearable device.

In a possible implementation, the operating modes of the electronic device include a performance mode, a hybrid mode, and a low-power mode. In the hybrid mode, the second processor is in a standby state while events are being processed through the first system and can be switched between a dormant state and a wake-up state (i.e., when the first system is in the wake-up state, the second system can be in the wake-up state or the dormant state). The names of the operating modes of the electronic device described above are for exemplary purposes only and do not constitute a limitation on the contents of the operating modes.

In some embodiments, when the first system is in the wake-up state, the electronic device displays a system interface of the first system, for example, the smartwatch displays a dial interface. In a possible application scenario, when the first system is in the wake-up state, the second system is in the dormant state; in another possible application scenario, when the first system is in the wake-up state, the second system is also in the wake-up state, and the first system is in a foreground operation state while the second system is in a background operation state.

In the present embodiments of the present disclosure, when the first system is in the wake-up state and the second system is in the dormant state, an incoming call notification sent by the terminal is received by the first system.

In some embodiments, when the second system is in the dormant state, the electronic device shuts down most of the hardware modules in the second processor and transfers all the relevant data of the second system to a dormant file on the hard disk (ROM), then cuts off the power supply to the second processor, and waits until the first system sends a wake-up message to the second system, at which time the electronic device restores power supply to the second processor, and the second system directly reads the contents of the dormant file on the hard disk directly into the memory (RAM), i.e., the second system switches to the wake-up state.

In order to ensure that the incoming call notification sent by the terminal can be received and processed in a timely manner, the electronic device is arranged with a communication component. During the operation of the electronic device, the first system can maintain a data communication connection with the terminal via the communication component, and receive the incoming call notification sent by the terminal via the data communication connection.

In some embodiments, the data communication connection is a Bluetooth connection, and the first system and the terminal realize the transmission of the incoming call notification information through the Bluetooth communication component.

In some embodiments, the incoming call notification contains at least one type of calling party information such as a calling party number, a calling party name, a calling party grouping, and a calling party attribution location.

Step 302: in a case where the second system is in a dormant state, performing, by the first system, an incoming call reminder based on the incoming call notification.

The first system carries out the incoming call reminder after receiving the incoming call notification sent by the terminal. In order to enable the user to determine whether to answer the incoming call, in some embodiments, the incoming call reminder is to include the corresponding calling party information of the incoming call.

Since the user may choose to answer the incoming call or hang up, the incoming call reminder further includes a corresponding operation module for answering and hanging up, such that the user can answer or hang up the incoming call.

In some embodiments, the incoming call reminder may be at least one of sound reminder, vibration reminder, and interface reminder, and the embodiments of the present disclosure do not limit in this regard.

Step 303: in response to an incoming call answering operation, waking up, by the first system, the second system.

In a possible implementation, when the user chooses to answer the incoming call, since the second system is in a dormant state, the first system is required to wake up the second system in order to realize the call function through the second system.

In some embodiments, the first system wakes up the second system by means of a dual-core communication; alternatively, the first system wakes up the second system by means of sending an interrupt, which is not limited by the embodiments.

In some embodiments, the incoming call answering operation may be a voice operation, a touch operation performed on a touch display of the electronic device, such as a click operation, a slide operation, a gesture operation, etc., and an operation performed on a physical button of the electronic device, such as a click button operation, a long press button operation, etc., which is not limited by the embodiments.

Step 304: sending, by the first system, an answering notification to the terminal.

In a possible implementation, after the first system wakes up the second system, the first system sends the answering notification to the terminal through a data communication connection with the terminal, thereby instructing the terminal to answer the incoming call.

Step 305: in a case where the second system is in a wake-up state, transmitting, by the second system, call data with the terminal.

In a possible implementation, in the wake-up state, the second system obtains a screen control authority of the electronic device from the first system, the call interface is displayed by the second system, and the second system transmits the call data of the local end via the data communication connection between the electronic device and the terminal, and receives the call data of the opposite end sent by the terminal, thereby realizing the call data transmission with the terminal.

In some embodiments, after switching to the second system, the first system remains in the wake-up state subsequently (low power consumption, which has a small impact on battery life), or the first system is switched to the dormant state, which is not limited by the embodiments.

In summary, in the embodiments of the present disclosure, for an electronic device supporting dual systems, in a case where the first system with lower power consumption is in a running state and the second system with higher power consumption is in a dormant state, when an incoming call notification sent by the terminal is received, an incoming call reminder is performed by the first system based on the incoming call notification. In response to an incoming call answering operation, the first system wakes up the second system and sends an answering notification to the terminal, and then the second system after awakening carries out call data transmission with the terminal. By virtue of the solution provided by embodiments of the present disclosure, in the presence of an incoming call, the low-power first system carries out the incoming call reminder, and in the presence of a call demand, the first system wakes up the high-power second system for incoming call processing, so as to ensure that the call function of the electronic device operates normally.

In some embodiments, the performing, by the first system, an incoming call reminder based on the incoming call notification includes:
displaying, by the first system, an incoming call notification interface based on the incoming call notification, where the incoming call notification interface includes an answer control;
the in response to an incoming call answering operation, waking up, by the first system, the second system includes:
in response to a triggering operation on the answer control, waking up, by the first system, the second system.

In some embodiments, the displaying, by the first system, an incoming call notification interface based on the incoming call notification includes:
obtaining, by the first system, interface resources corresponding to the incoming call notification interface, where the interface resources include control icon resources corresponding to the answer control, and the interface resources are provided by the second system;
drawing, by the first system, the incoming call notification interface based on the interface resources and calling party information contained in the incoming call notification, where the calling party information includes at least one of a calling party number, a calling party name, a calling party grouping, and a calling party attribution location; and
displaying, by the first system, the incoming call notification interface.

In some embodiments, after the receiving, by the first system, an incoming call notification sent by a terminal, the method further includes:
in a case where the second system is in the wake-up state, sending, by the first system, the incoming call notification to the second system;
drawing, by the second system, the incoming call notification interface based on interface resources and calling party information;
displaying, by the second system, the incoming call notification interface; and
in response to a triggering operation on the answer control, sending, by the second system, the answering notification to the terminal; transmitting, by the second system, call data with the terminal.

In some embodiments, in a case where the second system is in a dormant state and a pre-awakening condition is satisfied, sending, by the first system, a pre-awakening message to the second system; and
performing, by the second system, a pre-awakening operation based on the pre-awakening message.

In some embodiments, the incoming call notification contains calling party information, and the pre-awakening condition includes at least one of the following:
the calling party number in the calling party information belongs to a target number segment;
the calling party information contains a calling party name;
the calling party attribution location in the calling party information belongs to a target attribution location; and
the calling party grouping in the calling party information belongs to a target grouping.

In some embodiments, in a case where the pre-awakening condition is that a historical answering rate of the calling party number is greater than a threshold, the method further includes:
in response to the incoming call hang-up operation or the incoming call answering operation, updating, by the first system, the historical answering rate of the calling party number.

In some embodiments, the sending, by the first system, an answering notification to the terminal includes:
in a case where a status feedback notification sent by the second system is received, sending, by the first system, the answering notification to the terminal, where the status feedback notification is configured to characterize switching of the second system from the dormant state to the wake-up state;
the method further includes: in a case where the status feedback notification sent by the second system is not received within a target time period, re-waking up, by the first system, the second system.

In some embodiments, after the waking up, by the first system, the second system, the method further includes:
sending, by the first system, the incoming call notification to the second system; and
in a case where the second system is in the wake-up state, displaying, by the second system, a call interface based on the incoming call notification.

In some embodiments, the receiving, by the first system, an incoming call notification sent by a terminal includes:
receiving, by the first system, the incoming call notification sent by the terminal through a first communication connection with the terminal;
the transmitting, by the second system, call data with the terminal includes:
multiplexing, by the second system, the first communication connection with the terminal for call data transmission; or,
establishing, by the second system, a second communication connection with the terminal; and transmitting, by the second system, the call data with the terminal through the second communication connection.

In some embodiments, after the performing, by the first system, an incoming call reminder based on the incoming call notification, the method further includes:
in response to the incoming call hang-up operation, sending, by the first system, a hang-up notification to the terminal.

In some embodiments, in response to a call end operation, resuming, by the second system, the dormant state.

During the operation of the electronic device, after receiving the incoming call notification, in addition to answering it, there exists a situation in which this incoming call is hung up. Therefore, in a possible implementation, in response to the hang-up operation, the first system sends a hang-up notification to the terminal.

In some embodiments, when the user selects to hang up the incoming call, the first system sends a hang-up notification to the terminal in response to the hang-up operation, thereby instructing the terminal to hang up the incoming call.

In some embodiments, the hang-up operation may be a voice operation, a touch operation performed on a touch display of the electronic device, such as a click operation, a slide operation, a gesture operation, etc., and an operation performed on a physical button of the electronic device, such as a click button operation, a long press button operation, etc., which is not limited by the embodiments.

In a possible implementation, the first system sends a hang-up notification to the terminal through a data communication connection between the electronic device and the terminal.

In the embodiments, in a case where an incoming call exists but is hung up, the first system does not need to wake up the second system for incoming call processing, thereby avoiding the need to wake up the second system for each incoming call causing an increase in the power consumption of the device, and thus reducing the power consumption of the operation of the electronic device.

In order to allow the user to more accurately make a judgment on whether to answer the incoming call, in the embodiments, the electronic device is adopted with an interface notification for incoming call notification, such that the user can see the calling party information of the incoming call in the incoming call notification interface, and decide whether to answer the incoming call based on the calling party information. Moreover, in order to facilitate the user's answering and hanging up operations, the incoming call notification interface contains controls corresponding to the answering and hanging up operations, and the user can directly trigger the controls in the interface to carry out the corresponding answering and hanging up operations.

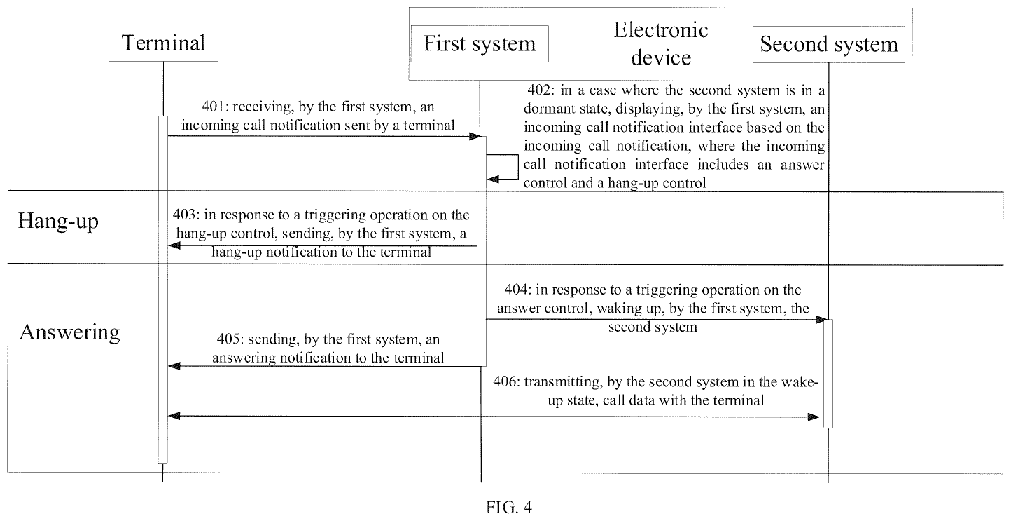

In a possible implementation, in a case where the first system is in a running state and the second system is in a dormant state, when the first system receives an incoming call notification from the terminal, it draws and displays an incoming call notification interface and processes the incoming call based on the answering and hanging up operations. Referring to FIG. 4, FIG. 4 is a flowchart of incoming call processing using an interface notification method according to some embodiments of the present disclosure. The method may include operations illustrated in FIG. 4.

Step 401: receiving, by the first system, an incoming call notification sent by a terminal.

The implementation of this step may be referred to as step 301, which will not be repeated herein.

Step 402: in a case where the second system is in a dormant state, displaying, by the first system, an incoming call notification interface based on the incoming call notification, where the incoming call notification interface includes an answer control and a hang-up control.

In order to enable the user to more accurately and conveniently determine whether or not he/she needs to answer the incoming call, in a case where the second system is in a dormant state, the first system displays the incoming call notification interface based on the incoming call notification after receiving the incoming call notification. In a case where both the first system and the second system are in a running state and the second system is capable of displaying the incoming call, the first system and the second system display the same incoming call notification interface. In a possible implementation, the specific implementation steps for the first system to display the incoming call notification interface are as follows:

Step 402A: obtaining, by the first system, interface resources corresponding to the incoming call notification.

In a possible implementation, the first system obtains interface resources corresponding to the incoming call notification interface, the interface resources including control icon resources corresponding to the answer control and the hang-up control. In some embodiments, the interface resources are provided by the second system to ensure the consistency of the incoming call interface displayed by different systems.

In the embodiments of the present disclosure, the first system and the second system each corresponds to a data storage space. In order to ensure the consistency of the incoming call interface displayed by the first system and the second system, when the second system is in the wake-up state, the first system obtains the interface resources corresponding to the incoming call notification interface from the second system, and stores the interface resources in the corresponding data storage space of the first system. When the first system has a demand for displaying the incoming call notification interface, the first system obtains the interface resources from its own corresponding data storage space.

In some embodiments, the interface resources refer to resources required for drawing the application interface, including control icon resources corresponding to the answer control and the hang-up control.

In some embodiments, the interface resources may further include text resources, image resources, animation resources, special effect resources, interface layout resources, etc., and the present embodiments do not limit the specific contents included in the interface resources.

Step 402B: drawing, by the first system, the incoming call notification interface based on the interface resources and the incoming call notification.

In a possible implementation, the first system draws the incoming call notification interface based on the interface resources and the calling party information contained in the incoming call notification, and the calling party information includes at least one of a calling party number, a calling party name, a calling party grouping, and a calling party attribution location.

In some embodiments, the calling party information may include, in addition to at least one of the calling party number, the calling party name, the calling party grouping, and the calling party attribution location, a calling party call time, the number of times the calling party has called, etc., and the present embodiments do not limit the specific contents included in the calling party information.

In some embodiments, the first system may need to utilize other data (e.g., time data) in addition to the calling party information contained in the incoming call notification during the drawing process of the incoming call notification interface, so as to ensure the accuracy of the contents in the drawn incoming call notification interface.

In an exemplary example, the interface resources obtained by the first system contain picture resources, text resources, and interface layout resources, and the first system draws the picture resources and the text resources at corresponding interface positions according to an interface element layout method indicated by interface layout resources to obtain the incoming call notification interface.

In some embodiments, in the process of drawing the incoming call notification interface, the first system obtains layout information of the interface, so as to display the incoming call notification interface based on the layout information. The layout information is configured to characterize how the calling party information is laid out in the incoming call notification interface.

In some embodiments, the layout information contains a display position, a display size, a display font, a font size, etc. of the calling party information in the incoming call notification interface, and the present embodiments do not limit the specific contents contained in the layout information.

Step 402C: displaying, by the first system, the incoming call notification interface.

The first system displays the incoming call notification interface after drawing the incoming call notification interface.

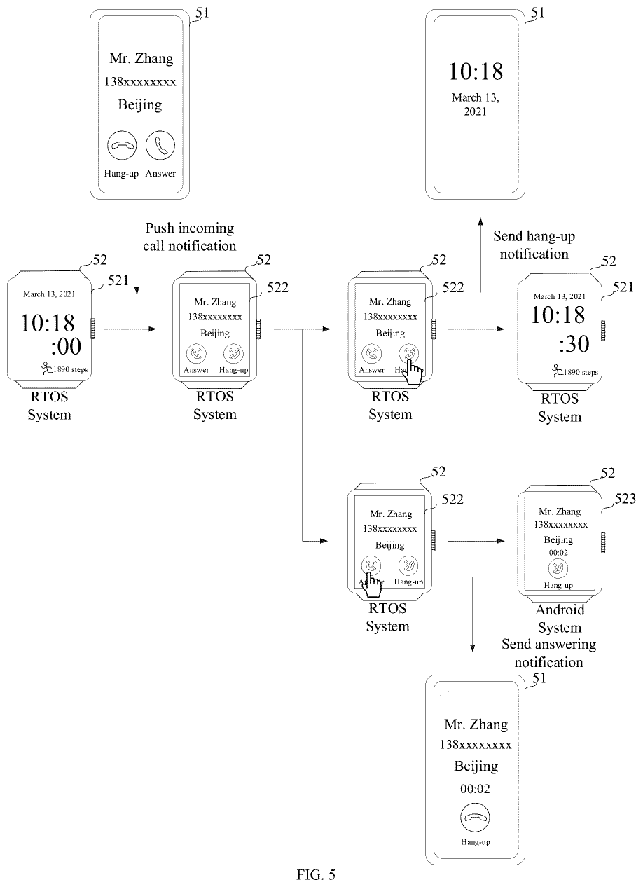

Schematically, as shown in FIG. 5, taking the wearable device being a smartwatch as an example, the smartwatch is provided with an RTOS system (the first system running on the first processor) and an Android system (the second system running on the second processor), and the smartwatch has a communication connection established via Bluetooth with a mobile phone. When the first processor is in a wake-up state and the second processor is in a dormant state, the RTOS system is in a wake-up state and the Android system is in a dormant state. The smartwatch 52 displays a dial interface 521 through the RTOS system, and the Android system is in the dormant state, thereby maintaining a low power consumption. When the mobile phone 51 receives an incoming call, the incoming call notification is pushed to the smartwatch 52, and after the smartwatch 52 receives the incoming call notification, the RTOS system displays the incoming call notification interface 522.

Step 403: in response to a triggering operation on the hang-up control, sending, by the first system, a hang-up notification to the terminal.

When the user selects to hang up the incoming call, in response to the triggering operation on the hang-up control, the first system sends a hang-up notification to the terminal through a data communication connection, thereby instructing the terminal to hang up the incoming call.

In some embodiments, the triggering operation on the hang-up control may be a click operation, a long-press operation, a swipe operation, etc., and the present embodiments do not limit this.

Schematically, as shown in FIG. 5, when the user sees the incoming call notification interface, if he/she does not want to or is not in a hurry to answer the call, the user may click on the hang-up control, and the RTOS system (first system) sends a hang-up notification to the mobile phone 51. In response to the hang-up notification, the mobile phone hangs up the incoming call, and the screen of the smartwatch continues to display the dial interface 521.

Step 404: in response to a triggering operation on the answer control, waking up, by the first system, the second system.

When the user selects to answer the incoming call, in response to the triggering operation on the answer control, the first system wakes up the second system.

In some embodiments, the triggering operation on the answer control may be a click operation, a long-press operation, a slide operation, etc., and the embodiments do not limit this.

Step 405: sending, by the first system, an answering notification to the terminal.

The implementation of this step can be referred to as step 304, which will not be repeated herein.

Step 406: transmitting, by the second system in the wake-up state, call data with the terminal.

It is to be understood that since the screen control authority of the electronic device is located in the first system when displaying the incoming call notification interface, the second system first needs to obtain the screen control authority from the first system, so as to display the call interface through the screen after obtaining the screen control authority.

The second system transmits call data of the local end and receives call data of the opposite end sent by the terminal through the communication connection, thereby realizing call data transmission with the terminal.

Schematically, as shown in FIG. 5, the RTOS system (first system) receives the incoming call notification and displays the incoming call notification interface 522. When the user sees the incoming call notification interface and confirms that it is a phone call that needs to be answered, he/she can perform a triggering operation on the answer control displayed in the incoming call notification interface 522. In response to a click operation on the answer control, the RTOS system (first system) wakes up the Android system (the second system) and sends an answering notification to the mobile phone 51. The mobile phone 51 answers the incoming call, the Android system in the wake-up state makes a voice call through the Bluetooth voice channel with the mobile phone 51, and the screen of the smartwatch displays a call interface 523.

Since the second system is required to display the call interface during the voice call with the terminal, and the call interface is required to contain some elements from the incoming call notification, in a possible implementation, the first system sends an incoming call notification to the second system; in the wake-up state, the second system displays the call interface based on the incoming call notification.

Schematically, as shown in FIG. 5, since the call interface 523 displayed by the Android system is required to include the calling party information in the incoming call notification, the RTOS system sends the incoming call notification to the Android system, and the Android system displays the call interface 523 based on the incoming call notification. The incoming call notification may include the calling party information, which may include, for example, at least one of the following: a calling party number, a calling party name, a calling party grouping, and a calling party attribution location.

In another possible implementation, in a case where both the first system and the second system are in the wake-up state, after the first system receives the incoming call notification sent by the terminal, the first system sends the incoming call notification to the second system, which displays the incoming call notification interface and processes the incoming call. The following is illustrated using exemplary embodiments.

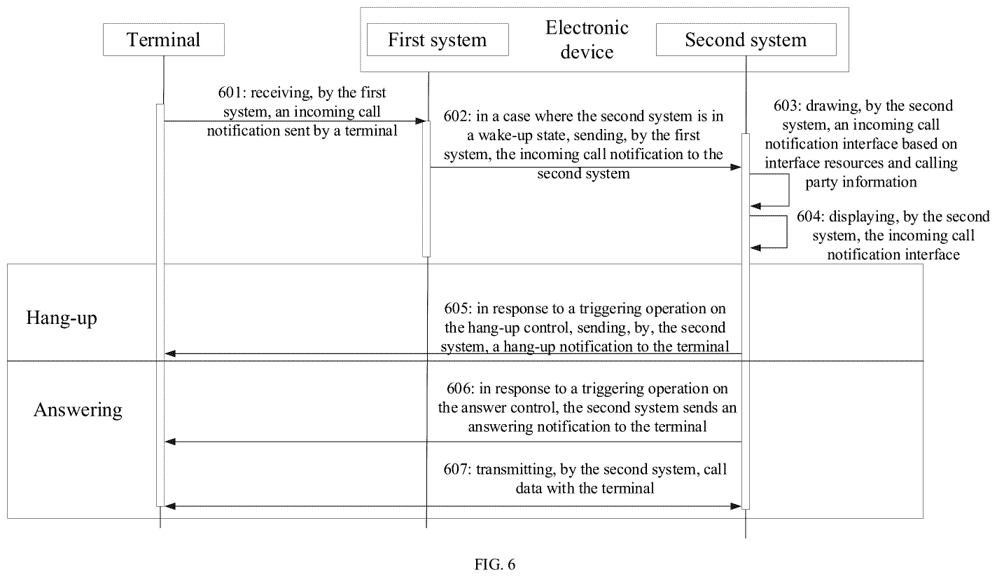

Referring to FIG. 6, FIG. 6 is a flowchart of incoming call processing using an interface notification method according to other embodiments of the present disclosure. The present embodiment is illustrated by an example in which the method is applied to an electronic device, and the electronic device supports running a first system and a second system (where the operation power consumption of the first system is lower than that of the second system), and the method may include operations illustrated in FIG. 6.

Step 601: receiving, by the first system, an incoming call notification sent by a terminal.

The implementation of this step may be referred to as step 301, which will not be repeated herein.

Step 602: in a case where the second system is in a wake-up state, sending, by the first system, the incoming call notification to the second system.

When the second system is in the wake-up state, the first system may directly send the incoming call notification to the second system for incoming call notification by the second system.

Step 603: drawing, by the second system, an incoming call notification interface based on interface resources and calling party information.

The second system obtains a screen control authority from the first system, and draws the incoming call notification interface based on the interface resources and the calling party information contained in the incoming call notification.

In some embodiments, the interface resources are stored in a storage space corresponding to the second system, and the second system obtains the interface resources from the storage space to draw the application interface. The process of drawing the incoming call notification interface by the second system can be referred to as step 402, which will not be repeated herein.

In some embodiments, the incoming call notification interface drawn by the second system is the same as the incoming call notification interface drawn by the first system.

Step 604: displaying, by the second system, the incoming call notification interface.

The second system displays the incoming call notification interface after drawing the incoming call notification interface.

In some embodiments, the second system obtains layout information of the interface during the incoming call notification interface, so as to display the incoming call notification interface based on the layout information, where the layout information is configured to characterize the way in which the calling party information is laid out in the incoming call notification interface.

In a possible implementation, the first system is in a foreground operation state, and the second system is in a background wake-up state. After the second system receives the incoming call notification sent by the first system, the second system obtains the screen control authority from the first system, thereby displaying the incoming call notification interface through the screen.

In another possible embodiment, the second system is in a foreground operation state and the first system is in a background operation state, i.e., the second system has the screen control authority. Upon receiving the incoming call notification sent by the first system, the second system may directly draw and display the incoming call notification interface based on the incoming call notification.

In some embodiments, regardless of whether the first system is in a foreground operation state or a background operation state, the terminal always transmits the incoming call notification message with the first system via a communication connection.

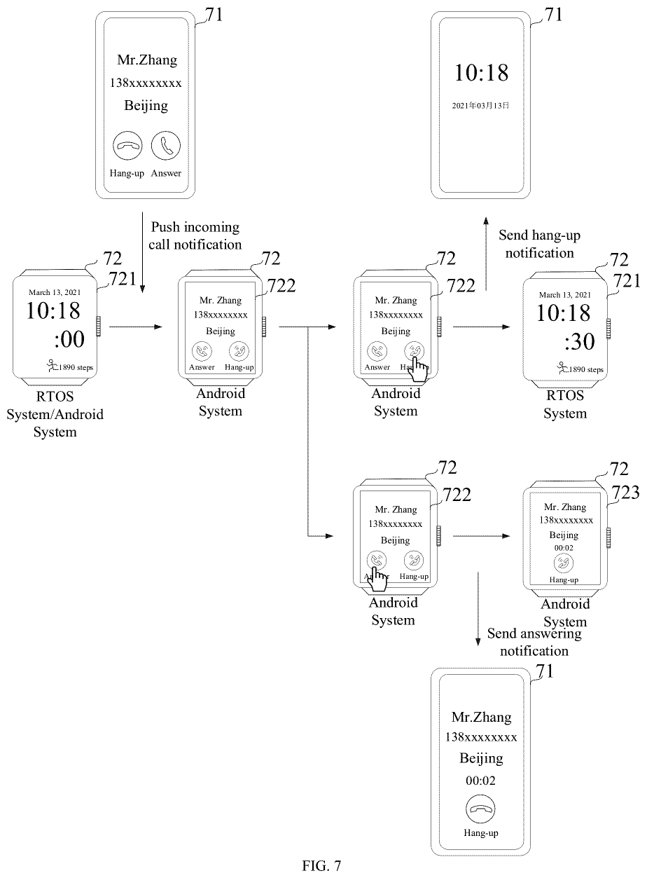

Schematically, as shown in FIG. 7, taking the wearable device being a smartwatch as an example, the smartwatch is provided with an RTOS system (the first system running on the first processor) and an Android system (the second system running on the second processor), and the smartwatch has a communication connection established via Bluetooth with a mobile phone. When both the first processor and the second processor are in a wake-up state, the RTOS system and the Android system are in a running state. After the mobile phone 71 receives the incoming call, the incoming call notification is pushed to the smartwatch 72, and after the smartwatch 72 receives the incoming call notification, the RTOS system sends the incoming call notification to the Android system, which controls the screen of the smartwatch 72 to display the incoming call notification interface 722.

Step 605: in response to a triggering operation on the hang-up control, sending, by, the second system, a hang-up notification to the terminal.

When the user selects to hang up the incoming call, in response to the triggering operation on the hang-up control, the second system sends a hang-up notification to the terminal through a communication connection, thereby instructing the terminal to hang up the incoming call.

In some embodiments, the triggering operation on the hang-up control may be a click operation, a long-press operation, a swipe operation, etc., and the present embodiments do not limit this.

Schematically, as shown in FIG. 7, when the user sees the incoming call notification interface, if he/she does not want to or is not in a hurry to answer the call, the user may click on the hang-up control, and in response to the triggering operation of the hang-up control, the Android system sends a hang-up notification to the mobile phone 71. In response to the hang-up notification, the mobile phone 71 hangs up the incoming call, and the screen of the smartwatch 72 continues to display the dial interface 721.

Step 606: in response to a triggering operation on the answer control, the second system sends an answering notification to the terminal.

When the user selects to answer the incoming call, in response to the triggering operation on the answer control, the second system sends the answering notification to the terminal through the communication connection, thereby instructing the terminal to answer the incoming call.

In some embodiments, the triggering operation on the answer control may be a click operation, a long-press operation, a slide operation, etc., and the embodiments do not limit this.

Step 607: transmitting, by the second system, call data with the terminal.

The second system transmits call data of the local end and receives call data of the opposite end sent by the terminal through the communication connection, thereby realizing call data transmission with the terminal.

Schematically, as shown in FIG. 7, when the user sees the incoming call notification interface and confirms that it is a call that needs to be answered, he/she may click on the answer control. In response to the triggering operation on the answer control, the Android system sends an answering notification to the mobile phone 71. The mobile phone 71 answers the incoming call, the Android system makes a voice call through the Bluetooth voice channel with the mobile phone 71, and the screen of the smartwatch displays a call interface 723.

In the above embodiments, for an electronic device supporting dual systems, in a case where the first system is in a running state and the second system is in a dormant state, an incoming call notification sent by the terminal is received, and the incoming call notification interface is first drawn and displayed by the first system. In response to a triggering operation on the hang-up control in the incoming call notification interface, the first system sends a hang-up notification to the terminal; in response to a triggering operation on the answer control in the incoming call notification interface, the first system wakes up the second system and sends an answering notification to the terminal, and then the woken up second system transmits the call data with the terminal, which makes it easier for the user to clarify the calling party information and determine whether to answer the incoming call, while saving power consumption.

Moreover, in a case where the first system and the second system are both in a running state, when an incoming call notification is received from the terminal, the first system sends the incoming call notification to the second system, and the second system draws and displays the incoming call notification interface. In response to the triggering operation on the hang-up control in the incoming call notification interface, the second system sends a hang-up notification to the terminal; in response to the triggering operation on the answer control in the incoming call notification interface, the second system sends an answering notification to the terminal, and then conducts a call data transmission with the terminal, which eliminates the need to wake up the second system by the first system and the time for the switching of the system, and further enables the user to clearly identify the calling party information to determine whether to answer the call.

In order to further reduce the power consumption of the electronic device and extend the endurance of the electronic device, in a possible implementation, in response to an end-of-call operation, the second system resumes the dormant state.

In some embodiments, the second system switches back to the dormant state after the end of the call, and the electronic device continues to process the event through the first system, such that the electronic device maintains high performance (but high power consumption) in a connected incoming call scenario and low power consumption (but low performance) in remaining scenarios, which ensures that the call function of the electronic device operates normally while further reducing the power consumption of the operation of the electronic device.

In another possible embodiment, after receiving the end-of-call operation, the second system maintains the wake-up state for a preset length of time. When a start-up operation on a target application is received within the preset length of time and the target application needs to be run under the second system, the second system does not enter the dormant state, thereby ensuring the normal operation of the target application. When the start-up operation on the target application is not received within the preset length of time, the second system will enter the dormant state again.

When the first system receives an incoming call notification, if the second system is in a dormant state, the first system wakes up the second system in response to the incoming call answering operation, and the wake-up process of the second system takes a certain amount of time (at least 200 ms to 300 ms). Therefore, there is a short period of unresponsive phenomenon after triggering the incoming call answering operation, which affects the use experience. Regarding the above, in a possible implementation, the first system pre-sets a pre-awakening condition. After receiving the incoming call notification, when the first system detects that the incoming call satisfies the pre-awakening condition, the first system sends a pre-awakening message to the second system, and the second system performs the pre-awakening operation. The following is illustrated using exemplary embodiments.

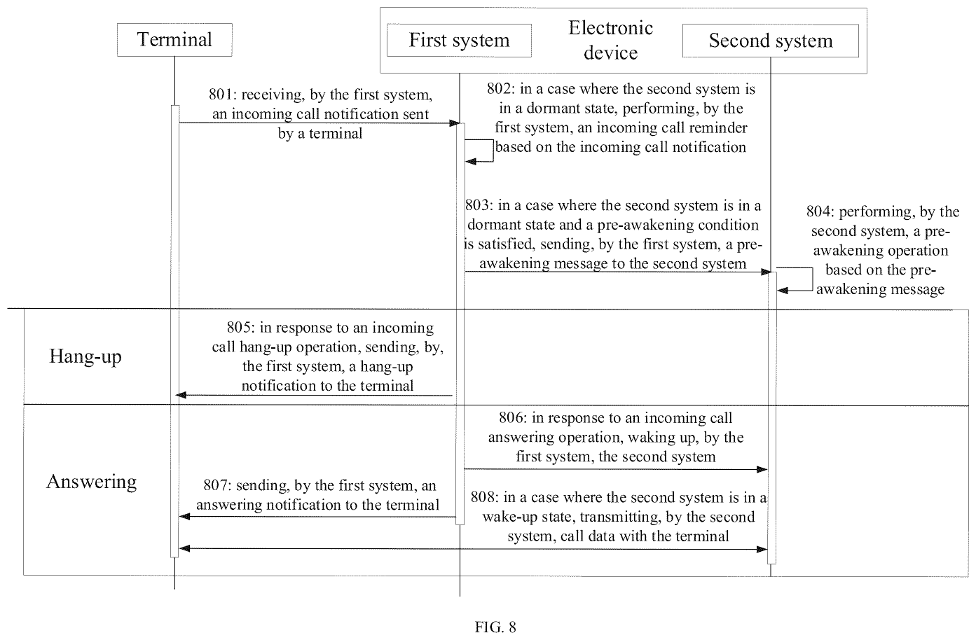

Referring to FIG. 8, FIG. 8 is a flowchart of an incoming call processing method using a pre-awakening method according to other embodiments of the present disclosure. The present embodiment is illustrated by an example in which the method is applied to an electronic device, and the electronic device supports running a first system and a second system, and the method may include operations illustrated in FIG. 8.

Step 801: receiving, by the first system, an incoming call notification sent by a terminal.

The implementation of this step may be referred to as step 301, which will not be repeated herein.

Step 802: in a case where the second system is in a dormant state, performing, by the first system, an incoming call reminder based on the incoming call notification.

The implementation of this step may be referred to as step 302, which will not be repeated herein.

Step 803: in a case where the second system is in a dormant state and a pre-awakening condition is satisfied, sending, by the first system, a pre-awakening message to the second system.

Since the wake-up process of the second system takes a certain amount of time, in order to reduce the delay in the system switching process, in some embodiments, the first system performs a look-up of the calling party information in the incoming call notification. When the looked-up information satisfies the pre-awakening condition, the first system determines that there is a higher probability of answering the current incoming call, and sends the pre-awakening message to the second system.

In a possible implementation, the pre-awakening condition includes at least one of the following:
the calling party number in the calling party information belongs to a target number segment;
the calling party information contains a calling party name;
the calling party attribution location in the calling party information belongs to a target attribution location;
the calling party grouping in the calling party information belongs to a target grouping.

In a schematic example, in a case where an internal landline number is assigned to an employee in a company, such as 0100-xxxxxxxxx, when the target number segment is set to 0100 and when the first system looks up and finds that this incoming call notification contains the 0100 number segment, the pre-awakening message is sent to the second system.

In a schematic example, because the incoming call notification of a saved contact will contain a contact name or a note, i.e., contain a calling party name, and the incoming call notification of an unknown contact does not contain a calling party name, when the first system finds a calling party name in the incoming call notification, the first system determines that it is a saved contact, and the first system sends the pre-awakening message to the second system.

In a schematic example, the incoming call notification contains a calling party attribution location, and when the target attribution location is set to be Beijing, i.e., when the first system finds that the calling party attribution location in this incoming call notification is Beijing, the first system sends the pre-awakening message to the second system.

In a schematic example, the calling party grouping refers to the grouping of saved contacts in the terminal, such as coworkers, family members, friends, customers, etc. Because incoming calls from the customer grouping are usually answered, when the customer grouping is set as the target grouping, and when the first system finds that the calling party grouping in the notification of the incoming call is the customer grouping, the first system sends the pre-awakening message to the second system.

In an illustrative example, a mapping relationship between the pre-awakening condition and the calling party information in the incoming call notification is shown in Table I.

TABLE I

| Pre-awakening condition | Calling party information |
|---|---|
| Calling party name | Mr. Zhang |
| Target attribution location | Beijing |
| Target number segment | 0100 |
| Target grouping | Customer |

The first system sends a pre-awakening message to the second system when it finds that at least one of the calling party information satisfies a mapping relationship between the pre-awakening condition and the calling party information in the incoming call notification.

Step 804: performing, by the second system, a pre-awakening operation based on the pre-awakening message.

In a case where the second system is in a dormant state, the second system performs the pre-awakening operation after the second system receives the pre-awakening message sent by the first system.

In a possible implementation, the second system wakes up as a whole set of operation processes. The second system is required to perform some preliminary operations before performing the wake-up operations, and after the preliminary operations are finished, the second system performs the wake-up operations and enters the wake-up state. In the embodiments of the present disclosure, the second system performs the pre-awakening operation after receiving the pre-awakening message sent by the first system. That is, the second system performs the pre-awakening operation as preliminary operations, waits for the pre-awakening message sent by the first system, and then performs the wake-up operation to complete the wake-up process.

In another possible embodiment, after the second system receives the pre-awakening message sent by the first system, the second system performs the pre-awakening operation. That is, after the second system performs the complete wake-up operation, it carries out the background operation, waits for the first system to send the wake-up message to the second system, and then the second system takes over the screen control authority, operates in the foreground, and completes the wake-up process.

Step 805: in response to an incoming call hang-up operation, sending, by, the first system, a hang-up notification to the terminal.

In response to the hang-up operation, the first system sends a hang-up notification to the terminal via a communication connection, thereby instructing the terminal to hang up this incoming call.

Step 806: in response to an incoming call answering operation, waking up, by the first system, the second system.

In response to the incoming call answering operation, the first system sends a wake-up message to the second system, and the second system, after receiving the wake-up message, performs the wake-up operation to complete the wake-up process.

At step 807: sending, by the first system, an answering notification to the terminal.

The implementation of this step may be referred to as step 304, which will not be repeated herein.

Step 808: in a case where the second system is in a wake-up state, transmitting, by the second system, call data with the terminal.

The implementation of this step may be referred to as step 305, which will not be repeated herein.

In some embodiments, in addition to determining whether a pre-awakening is required based on the calling party information, the first system may further determine whether a pre-awakening is required based on the user's history of answering records.

In another possible implementation, the pre-awakening condition is that the historical answering rate of the calling party number is greater than a threshold value.

In some embodiments, the threshold value may be 0.5. Since an incoming call has two possibilities of answering and hanging up, i.e., the probability of an incoming call being answered and hung up is 0.5, if the historical answering rate of the calling party number of the current incoming call is greater than 0.5, it means that the number of times this number has been answered is greater than the number of times this number has been hung up, and if the historical answering rate of the calling party number of the current incoming call is less than 0.5, it means that the number of times this number has been answered is less than the number of times this number has been hung up. Accordingly, the first system sends a pre-awakening message to the second system in a case where the historical answering rate of the calling party number is greater than the threshold value.

In a schematic example, the first system, after receiving an incoming call notification sent by the terminal, detects the historical answering rate of the calling party number for this incoming call. Assuming that the pre-set threshold is 0.5, if the historical answering rate is greater than 0.5, the number of times this calling party number has been answered is greater than the number of times it has been hung up, there is a greater likelihood that this calling party number will be answered, and the first system sends the pre-awakening message to the second system. If the historical answering rate is less than 0.5, it means that the number of times this calling party number has been answered is less than the number of times it has been hung up, and there is a greater likelihood that this calling party number will not be answered, and the first system does not send the pre-awakening message to the second system.

Accordingly, in response to the incoming call hang-up operation or the incoming call answering operation, the first system updates the historical answering rate of the calling party number.

In some embodiments, the information of historical answering rate is saved in a storage space corresponding to the first system, and after each incoming call processing, the first system updates the historical answering rate of the calling party number saved in the storage space. When an incoming call is received, the first system detects its calling party number, obtains the historical answering rate of this calling party number from the storage space, and compares the corresponding historical answering rate with the threshold. If the historical answering rate of this calling party number is greater than the threshold, the first system sends a pre-awakening message to the second system.

In the embodiments, when the second system is in a dormant state and the pre-awakening condition is met, the first system determines whether to send a pre-awakening message to the second system based on the pre-set pre-awakening conditions, and then the second system performs the pre-awakening operation based on the pre-awakening message, which improves the accuracy of the pre-awakening operation, accelerates the wake-up speed of the second system, and reduces the reception delay of the second system when it wakes up.

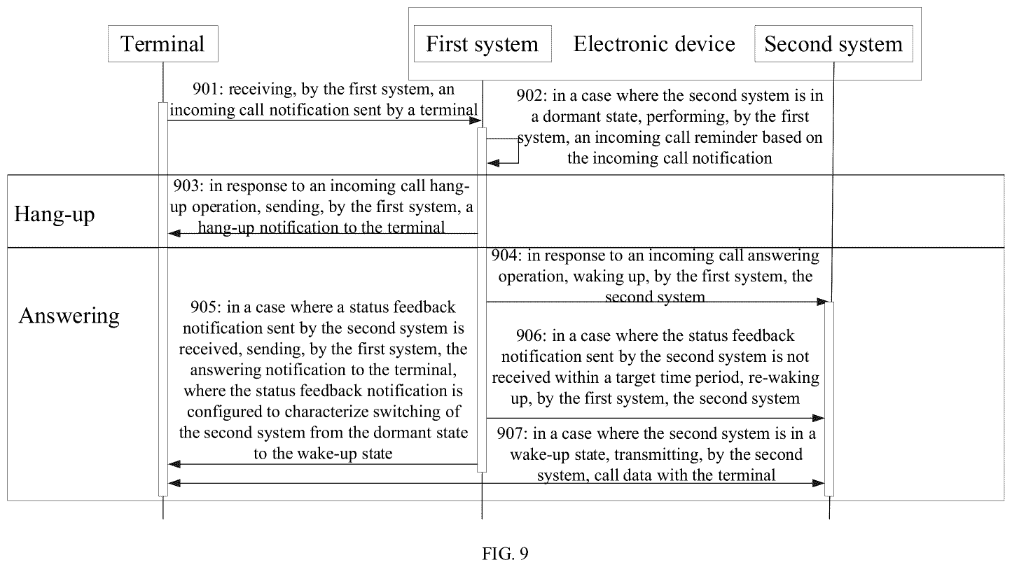

Referring to FIG. 9, FIG. 9 is a flowchart of an incoming call processing method according to other embodiments of the present disclosure. The present embodiment is illustrated by an example in which the method is applied to an electronic device, and the electronic device supports running a first system and a second system, and the method may include operations illustrated in FIG. 9.

Step 901: receiving, by the first system, an incoming call notification sent by a terminal.

The implementation of this step may be referred to as step 301, which will not be repeated herein.

Step 902: in a case where the second system is in a dormant state, performing, by the first system, an incoming call reminder based on the incoming call notification.

The implementation of this step may be referred to as step 302, which will not be repeated herein.

Step 903: in response to an incoming call hang-up operation, sending, by the first system, a hang-up notification to the terminal.

In response to an incoming call hang-up operation, the first system sends a hang-up notification to the terminal via a communication connection, thereby instructing the terminal to hang up the incoming call.

Step 904: in response to an incoming call answering operation, waking up, by the first system, the second system.

The implementation of this step may be referred to as step 303, which will not be repeated herein.

Step 905: in a case where a status feedback notification sent by the second system is received, sending, by the first system, the answering notification to the terminal, where the status feedback notification is configured to characterize switching of the second system from the dormant state to the wake-up state.

After the second system wakes up, it sends the status feedback notification to the first system. After the first system receives the status feedback notification sent by the second system, it confirms that the second system has switched from the dormant state to the wake-up state, and the first system sends the answering notification to the terminal through the communication connection, thereby instructing the terminal to answer the incoming call.

Step 906: in a case where the status feedback notification sent by the second system is not received within a target time period, re-waking up, by the first system, the second system.

When the first system does not receive the status feedback notification sent by the second system within a certain time duration (e.g., 1 s, 2 s, etc.), the first system will re-send a wake-up message to the second system.

Step 907: in a case where the second system is in a wake-up state, transmitting, by the second system, call data with the terminal.

In the wake-up state, the second system obtains the screen control authority of the electronic device from the first system, i.e., the call interface is displayed by the second system, and the second system transmits the call data of the home end and receives the call data of the opposite end sent by the terminal through the communication connection, thereby realizing the call data transmission with the terminal.

In a possible implementation, the first system receives the incoming call notification sent by the terminal through a first communication connection with the terminal.

Accordingly, the transmitting, by the second system, call data with the terminal includes:
multiplexing, by the second system, the first communication connection with the terminal for call data transmission; or,
establishing, by the second system, a second communication connection with the terminal; and transmitting, by the second system, the call data with the terminal through the second communication connection.

In order to ensure that the incoming call notification sent by the terminal can be received and processed in a timely manner, in some embodiments, a communication component is arranged on the first processor, such that the terminal and the first system can maintain a communication connection (the communication connection between the first system and the terminal is referred to as the first communication connection) while maintaining a low power consumption during the operation of the electronic device. It is to be noted that when the second system is awakened and is in a foreground operation state (in which case the first system is switched to a background operation state), the data communication connection between the first system and the terminal is still maintained. That is, during the operation of the electronic device, regardless of whether an incoming call notification sent by the terminal is required to be answered, i.e., whether it is required to be processed by the second system, the electronic device carries out the transmission of communication data through the first communication connection.

In some embodiments, the first system receives the incoming call notification sent by the terminal through the first communication connection with the terminal, and the second system multiplexes the first communication connection to carry out the call data transmission with the terminal.

In addition, since the communication component is arranged on the first processor, the first system is in a running state (switching between foreground and background operation state) throughout the operation of the electronic device, which ensures that the incoming call notification is processed in a timely manner and maintains low power consumption (if the communication component is arranged on the second system, it is necessary to wake up the second system frequently, resulting in increased power consumption).

In other embodiments, each of the first processor and the second processor of the electronic device is arranged with the communication component. When the electronic device only needs the first system to process events, the second processor is controlled to be in the dormant state (the second system is in the dormant state), and the terminal and the electronic device are kept in a communication connection through the communication component arranged on the first processor. When the electronic device needs the second system to make a voice call, the first processor can be either in the wake-up state or in the dormant state, and the terminal and the electronic device switch to be communicatively connected through the communication connection component arranged on the second processor. The communication connection between the second system and the terminal is referred to as the second communication connection.

In some embodiments, the first system receives the incoming call notification sent by the terminal through the first communication connection with the terminal, and after the second system wakes up, the second system establishes the second communication connection with the terminal and transmits call data with the terminal through the second communication connection.

In some embodiments, the data communication connection is a Bluetooth connection, and the electronic device and the terminal realize the call data transmission through a Bluetooth communication component.

In the embodiments, the first system sends the answering notification to the terminal upon receiving the status feedback notification sent by the second system, which ensures that the second system must be in a wake-up state at this time, avoiding that the second system is still not waking up when an incoming call is answered, and in addition, clarifies the data transmission method between the electronic device and the terminal, such that the second system can successfully complete the call data transmission with the terminal.

In a possible embodiment, when the electronic device is in the hybrid mode, the scheme provided in the above embodiments is adopted to handle the incoming call. The operating modes of the electronic device further include a performance mode and a low-power mode in addition to the hybrid mode.

In the performance mode, both the second processor and the first processor remain in the wake-up state (accordingly, both the first system and the second system are in the wake-up state). When the first system receives an incoming call notification sent by the terminal, the first system sends the incoming call notification to the second system, and the second system carries out the incoming call reminder. In a case where the incoming call is required to be hung up, the second system sends a hang-up notification to the terminal, and similarly, in a case where the incoming call is required to be answered, the second system directly sends an answering notification to the terminal and transmits the call data with the terminal. The electronic device in the performance mode is capable of carrying out incoming call notification and incoming call processing, but keeping the second system in operation for a long period of time, which will result in unnecessary power consumption of the device and reduce the endurance of the electronic device.

In addition, in the low-power mode, only the first processor maintains the wake-up state and the second processor maintains an off state (i.e., the first system is in the wake-up state and the second system is in the off state). When the first system receives an incoming call notification sent by the terminal, the incoming call reminder is performed by the first system based on the incoming call notification, and in response to an incoming call hang-up operation, the first system sends a hang-up notification to the terminal. Since the second system always remains off in the low-power mode, the electronic device is unable to answer the incoming call normally and can only perform incoming call reminder and incoming call hang-up. That is, the electronic device in the low-power mode is unable to realize the normal call function although it operates with lower power consumption.

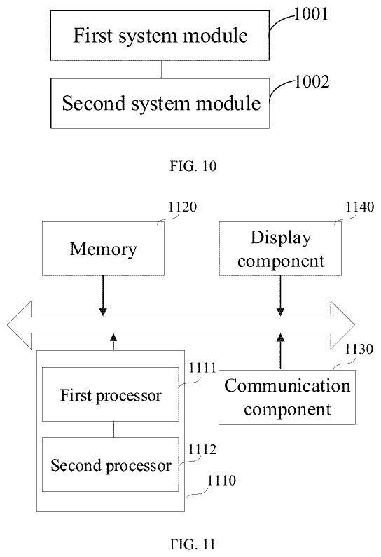

Referring to FIG. 10, FIG. 10 is a structural block diagram of an incoming call processing apparatus according to some embodiments of the present disclosure. The apparatus may be realized as all or part of an electronic device through software, hardware, or a combination of both. The apparatus includes:
a first system module 1001, configured to for receive an incoming call notification sent by a terminal, where a communication connection is established between the terminal and the electronic device.

The first system module 1001 is further configured to, in a case where a second system module 1002 is in a dormant state, perform an incoming call reminder based on the incoming call notification.

The first system module 1001 is further configured to wake up the second system module 1002 in response to an incoming call answering operation; the first system module 1001 is further configured to send an answering notification to the terminal; and the second system module 1002 is further configured to, in a case where the second system module 1002 is in a wake-up state, transmit call data with the terminal.

In some embodiments, the first system module 1001 is further configured to:
display an incoming call notification interface based on the incoming call notification, where the incoming call notification interface includes an answer control;
the first system module 1001, is specifically configured to:
wake up the second system module 1002 in response to a triggering operation on the answer control.

In some embodiments, the first system module 1001 is further configured to:
obtain interface resources corresponding to the incoming call notification interface, where the interface resources include control icon resources corresponding to the answer control, and the interface resources are provided by the second system module 1002;
draw the incoming call notification interface based on the interface resources and calling party information contained in the incoming call notification, where the calling party information includes at least one of a calling party number, a calling party name, a calling party grouping, and a calling party attribution location; and
display the incoming call notification interface.

In some embodiments, the first system module 1001 is further configured to:
send the incoming call notification to the second system module 1002 in a case where the second system module 1002 is in the wake-up state;
the second system module 1002 is further configured to:
draw the incoming call notification interface based on the interface resources and the calling party information;
display the incoming call notification interface; and
send the answering notification to the terminal in response to a triggering operation on the answer control; and transmit call data with the terminal.

In some embodiments, the first system module 1001 is further configured to:
send a pre-awakening message to the second system module 1002 in a case where the second system module 1002 is in a dormant state and a pre-awakening condition is satisfied;
the second system module 1002 is further configured to perform a pre-awakening operation based on the pre-awakening message.

In some embodiments, the incoming call notification contains calling party information, and the pre-awakening condition includes at least one of the following:
the calling party number in the calling party information belongs to a target number segment;
the calling party information contains a calling party name;
the calling party attribution location in the calling party information belongs to a target attribution location; and
the calling party grouping in the calling party information belongs to a target grouping.

In some embodiments, the pre-awakening condition is that a historical answering rate of the calling party number is greater than a threshold;

The first system module 1001 is further configured to:
update the historical answering rate of the calling party number in response to the incoming call hang-up operation or the incoming call answering operation.

In some embodiments, the first system module 1001 is further configured to:
send the answering notification to the terminal in a case where a status feedback notification sent by the second system module 1002 is received; where the status feedback notification is configured to characterize switching of the second system module 1002 from the dormant state to the wake-up state; and;
the first system module 1001 is further configured to:
re-wake up the second system module in a case where the status feedback notification sent by the second system module 1002 is not received within a target time period.

In some embodiments, the first system module 1001 is further configured to:
send the incoming call notification to the second system module;
the second system module 1002 is further configured to:
display a call interface based on the incoming call notification in a case where the second system module 1002 is in the wake-up state.

In some embodiments, the first system module 1001 is further configured to:
receive the incoming call notification sent by the terminal through a first communication connection with the terminal;
the second system module 1002 is further configured to:
multiplex the first communication connection with the terminal for call data transmission; or,
establish a second communication connection with the terminal; and transmit call data with the terminal through the second communication connection.

In some embodiments, the first system module 1001 is further configured to:
send a hang-up notification to the terminal in response to the incoming call hang-up operation.

In some embodiments, the second system module 1002 is further configured to:
resume the dormant state in response to a call end operation.

In summary, in the embodiments of the present disclosure, for an electronic device supporting dual systems, in a case where the first system with lower power consumption is in a running state and the second system with higher power consumption is in a dormant state, when an incoming call notification sent by the terminal is received, an incoming call reminder is performed by the first system based on the incoming call notification. In response to an incoming call answering operation, the first system wakes up the second system and sends an answering notification to the terminal, and then the second system after awakening carries out call data transmission with the terminal. By virtue of the solution provided by embodiments of the present disclosure, in the presence of an incoming call, the low-power first system carries out the incoming call reminder, and in the presence of a call demand, the first system wakes up the high-power second system for incoming call processing, so as to ensure that the call function of the electronic device operates normally.

In the embodiments, in a case where an incoming call exists but is hung up, the first system does not need to wake up the second system for incoming call processing, thereby avoiding the need to wake up the second system for each incoming call causing an increase in the power consumption of the device, and thus reducing the power consumption of the operation of the electronic device.

In the above embodiments, for an electronic device supporting dual systems, in a case where the first system is in a running state and the second system is in a dormant state, an incoming call notification sent by the terminal is received, and the incoming call notification interface is first drawn and displayed by the first system. In response to a triggering operation on the hang-up control in the incoming call notification interface, the first system sends a hang-up notification to the terminal; in response to a triggering operation on the answer control in the incoming call notification interface, the first system wakes up the second system and sends an answering notification to the terminal, and then the woken up second system transmits the call data with the terminal, which makes it easier for the user to clarify the calling party information and determine whether to answer the incoming call.

Moreover, in a case where the first system and the second system are both in a running state, when an incoming call notification is received from the terminal, the first system sends the incoming call notification to the second system, and the second system draws and displays the incoming call notification interface. In response to the triggering operation on the hang-up control in the incoming call notification interface, the second system sends a hang-up notification to the terminal; in response to the triggering operation on the answer control in the incoming call notification interface, the second system sends an answering notification to the terminal, and then conducts a call data transmission with the terminal, which eliminates the need to wake up the second system by the first system and the time for the switching of the system, and further enables the user to clearly identify the calling party information to determine whether to answer the call.

In the embodiments, when the second system is in a dormant state and the pre-awakening condition is met, the first system determines whether to send a pre-awakening message to the second system based on the pre-set pre-awakening conditions, and then the second system performs the pre-awakening operation based on the pre-awakening message, which improves the accuracy of the pre-awakening operation, accelerates the wake-up speed of the second system, and reduces the reception delay of the second system when it wakes up.

In the embodiments, the first system sends the answering notification to the terminal upon receiving the status feedback notification sent by the second system, which ensures that the second system must be in a wake-up state at this time, avoiding that the second system is still not waking up when an incoming call is answered, and in addition, clarifies the data transmission method between the electronic device and the terminal, such that the second system can successfully complete the call data transmission with the terminal.

Referring to FIG. 11, FIG. 11 is a structural block diagram of an electronic device according to some embodiments of the present disclosure. The electronic device of the present disclosure may include one or more of the following components: a processor 1110 and a memory 1120.

In some embodiments, the processor 1110 includes at least a first processor 1111 and a second processor 1112, where the first processor 1111 is configured to run a first system and the second processor 1112 is configured to run a second system, and the power consumption of the first processor 1111 is lower than that of the second processor 1112, while the performance of the first processor 1111 is lower than that of the second processor 1112. The processor 1110 utilizes various interfaces and wiring to connect various portions within the entire electronic device to perform various functions of the electronic device and process data by running or executing instructions, programs, code sets, or sets of instructions stored in the memory 1120, and by calling up data stored in the memory 1120. In some embodiments, the processor 1110 may be realized in at least one form of hardware: Digital Signal Processing (DSP), Field-Programmable Gate Array (FPGA), Programmable Logic Array (PLA). The processor 1110 may integrate one or a combination of a Central Processing Unit (CPU), a Graphics Processing Unit (GPU), a Neural-network Processing Unit (NPU), and a modem. The CPU mainly handles the operating system, user interface, and application programs, etc.; the GPU is responsible for rendering and drawing the content to be displayed by the touch screen; the NPU is responsible for implementing artificial intelligence (AI) functions; and the modem is responsible for handling wireless communication. It is to be understood that the modem may not be integrated into the processor 1110, and be implemented through a chip alone.

The memory 1120 may include Random Access Memory (RAM) or may include Read-Only Memory (ROM). In some embodiments, the memory 1120 includes a non-transitory computer-readable storage medium. The memory 1120 may be configured to store instructions, programs, code, code sets, or instruction sets. The memory 1120 may include a storage program area and a storage data area, where the storage program area may store instructions for implementing the operating system, instructions for at least one function (e.g., a touch function, a sound playback function, an image playback function, etc.), instructions for implementing each of the method embodiments described above, etc.; the storage data area may store data (such as audio data, phonebooks) created based on the use of wearable devices, etc.

The electronic device in the embodiments of the present disclosure further includes a communication component 1130 and a display component 1140, where the communication component 1130 may be a Bluetooth component, a Wireless Fidelity (Wi-Fi) component, a Near Field Communication (NFC) component, etc., for communicating with an external device (a server or a wireless network) via a wired or wireless network; and the display component 1140 is configured to perform a graphical user interface display, and/or, receive user interaction.

In addition, it will be understood by those skilled in the art that the structure of the electronic device illustrated in the above-described accompanying drawings does not constitute a limitation of the electronic device, and that the electronic device may include more or fewer components than illustrated, or a combination of certain components, or a different arrangement of components. For example, the electronic device further includes components such as a radio frequency circuit, an input unit, a sensor, an audio circuit, a speaker, a microphone, a power supply, etc., which will not be described herein.

The embodiments of the present disclosure further provide a computer-readable storage medium storing at least one instruction, the at least one instruction being configured to be executed by a processor to realize an incoming call processing method as described in the above embodiments.

The embodiments of the present disclosure further provide a computer program product, including computer instructions, where the computer instructions are stored in a computer-readable storage medium. A processor of the electronic device reads the computer instructions from the computer-readable storage medium, and the processor executes the computer instructions such that the electronic device performs the incoming call processing method provided by the above embodiments.

It should be understood by those skilled in the art that in one or more of the above examples, the functionality described in the embodiments of the present disclosure may be implemented using hardware, software, firmware, or any combination thereof. When implemented using software, the functions may be stored in a computer-readable medium or transmitted as one or more instructions or code on a computer-readable medium. The computer-readable medium includes computer storage medium and communication medium, where the communication medium includes any medium that facilitates the transmission of a computer program from one location to another, and the storage medium may be any available medium to which a general purpose or specialized computer has access.

The foregoing are only some embodiments of the present disclosure and are not intended to limit the present disclosure. Any modifications, equivalent substitutions, improvements, etc. made within the spirit and principles of the present disclosure shall be included in the scope of the present disclosure.

What is claimed is:

1. An incoming call processing method, performed by an electronic device; wherein the electronic device supports running a first system and a second system, and an operation power consumption of the first system is lower than an operation power consumption of the second system;
wherein the incoming call processing method comprises:
receiving, by the first system, an incoming call notification sent by a terminal; wherein a communication connection is established between the terminal and the electronic device;
in a case where the second system is in a dormant state, performing, by the first system, an incoming call reminder based on the incoming call notification; and
in response to an incoming call answering operation, waking up, by the first system, the second system; sending, by the first system, an answering notification to the terminal; and in a case where the second system is in a wake-up state, transmitting, by the second system, call data with the terminal.

2. The method according to claim 1, wherein the performing, by the first system, an incoming call reminder based on the incoming call notification comprises:
displaying, by the first system, an incoming call notification interface based on the incoming call notification; wherein the incoming call notification interface comprises an answer control;
the in response to an incoming call answering operation, waking up, by the first system, the second system comprises:
in response to a triggering operation on the answer control, waking up, by the first system, the second system.

3. The method according to claim 2, wherein the displaying, by the first system, an incoming call notification interface based on the incoming call notification comprises:
obtaining, by the first system, interface resources corresponding to the incoming call notification interface; wherein the interface resources comprise control icon resources corresponding to the answer control, and the interface resources are provided by the second system;
drawing, by the first system, the incoming call notification interface based on the interface resources and calling party information contained in the incoming call notification; wherein the calling party information comprises at least one of a calling party number, a calling party name, a calling party grouping, and a calling party attribution location; and
displaying, by the first system, the incoming call notification interface.

4. The method according to claim 2, after the receiving, by the first system, an incoming call notification sent by a terminal, further comprising:
in a case where the second system is in the wake-up state, sending, by the first system, the incoming call notification to the second system;
displaying, by the second system, the incoming call notification interface; and
in response to the triggering operation on the answer control, sending, by the second system, the answering notification to the terminal; transmitting, by the second system, call data with the terminal;
wherein the incoming call notification interface displayed by the first system is consistent with the incoming call notification interface displayed by the second system.

5. The method according to claim 1, further comprising:
in a case where the second system is in the dormant state and a pre-awakening condition is satisfied, sending, by the first system, a pre-awakening message to the second system; and
performing, by the second system, a pre-awakening operation based on the pre-awakening message.

6. The method according to claim 5, wherein the incoming call notification contains calling party information, and the pre-awakening condition comprises at least one of the following:
that a calling party number in the calling party information belongs to a target number segment;
that the calling party information contains a calling party name;
that a calling party attribution location in the calling party information belongs to a target attribution location; and
that a calling party grouping in the calling party information belongs to a target grouping.

7. The method according to claim 5, wherein the pre-awakening condition is that a historical answering rate of a calling party number is greater than a threshold, and the method further comprises:
in response to an incoming call hang-up operation or the incoming call answering operation, updating, by the first system, the historical answering rate of the calling party number.

8. The method according to claim 1, wherein the in response to an incoming call answering operation, waking up, by the first system, the second system comprises:
waking up, by the first system, the second system by means of a dual-core communication; or,
waking up, by the first system, the second system by means of sending an interrupt.

9. The method according to claim 1, wherein the sending, by the first system, an answering notification to the terminal comprises:
after the first system wakes up the second system, sending, by the first system, the answering notification to the terminal through a data communication connection with the terminal, for instructing the terminal to answer the incoming call.

10. The method according to claim 1, after the waking up, by the first system, the second system, further comprising:
sending, by the first system, the incoming call notification to the second system; and
in a case where the second system is in the wake-up state, displaying, by the second system, a call interface based on the incoming call notification.

11. The method according to claim 1, wherein the receiving, by the first system, an incoming call notification sent by a terminal comprises:
receiving, by the first system, the incoming call notification sent by the terminal through a first communication connection with the terminal;
the transmitting, by the second system, call data with the terminal comprises:
multiplexing, by the second system, the first communication connection with the terminal for call data transmission; or,
establishing, by the second system, a second communication connection with the terminal; and
transmitting, by the second system, the call data with the terminal through the second communication connection.

12. The method according to claim 1, after the performing, by the first system, an incoming call reminder based on the incoming call notification, further comprising:
in response to an incoming call hang-up operation, sending, by the first system, a hang-up notification to the terminal.

13. The method according to claim 1, further comprising:
in response to a call end operation, resuming, by the second system, the dormant state.

14. The method according to claim 1, wherein the first system keeps in a running state during an operation of the electronic device.

15. The method according to claim 1, wherein the electronic device comprises a first processor and a second processor with different processing capabilities and/or power consumption; the first processor is configured to run the first system, and the second processor is configured to run the second system; or,
the electronic device is arranged with a single processor, wherein the first system and the second system run on different cores of the processor.

16. An electronic device, comprising a processor and a memory; wherein the electronic device supports running a first system and a second system, and an operation power consumption of the first system is lower than an operation power consumption of the second system; wherein the memory stores at least one instruction configured to be executed by the processor to perform:
receiving, by the first system, an incoming call notification sent by a terminal; wherein a communication connection is established between the terminal and the electronic device;
in a case where the second system is in a dormant state, performing, by the first system, an incoming call reminder based on the incoming call notification; and
in response to an incoming call answering operation, waking up, by the first system, the second system; sending, by the first system, an answering notification to the terminal; and in a case where the second system is in a wake-up state, transmitting, by the second system, call data with the terminal.

17. The electronic device according to claim 16, wherein the performing, by the first system, an incoming call reminder based on the incoming call notification comprises:
displaying, by the first system, an incoming call notification interface based on the incoming call notification; wherein the incoming call notification interface comprises an answer control;
the in response to an incoming call answering operation, waking up, by the first system, the second system comprises:
in response to a triggering operation on the answer control, waking up, by the first system, the second system.

18. The electronic device according to claim 17, wherein the displaying, by the first system, an incoming call notification interface based on the incoming call notification comprises:
obtaining, by the first system, interface resources corresponding to the incoming call notification interface; wherein the interface resources comprise control icon resources corresponding to the answer control, and the interface resources are provided by the second system;
drawing, by the first system, the incoming call notification interface based on the interface resources and calling party information contained in the incoming call notification; wherein the calling party information comprises at least one of a calling party number, a calling party name, a calling party grouping, and a calling party attribution location; and
displaying, by the first system, the incoming call notification interface.

19. The electronic device according to claim 18, wherein after the receiving, by the first system, an incoming call notification sent by a terminal, the processor is further caused to perform:
in a case where the second system is in the wake-up state, sending, by the first system, the incoming call notification to the second system;
drawing, by the second system, the incoming call notification interface based on the interface resources and the calling party information;
displaying, by the second system, the incoming call notification interface; and
in response to the triggering operation on the answer control, sending, by the second system, the answering notification to the terminal; transmitting, by the second system, call data with the terminal.

20. A non-transitory computer-readable storage medium for an electronic device; wherein the electronic device supports running a first system and a second system, and an operation power consumption of the first system is lower than an operation power consumption of the second system; the storage medium stores at least one instruction configured to be executed by a processor to perform:
receiving, by the first system, an incoming call notification sent by a terminal; wherein a communication connection is established between the terminal and the electronic device;
in a case where the second system is in a dormant state, performing, by the first system, an incoming call reminder based on the incoming call notification; and
in response to an incoming call answering operation, waking up, by the first system, the second system; sending, by the first system, an answering notification to the terminal; and in a case where the second system is in a wake-up state, transmitting, by the second system, call data with the terminal.
